(19) United States
(12) Patent Application Publication
(10) Pub. No.: US 2014/0015858 A1
(43) Pub. Date: Jan. 16, 2014

(54) AUGMENTED REALITY SYSTEM

(71) Applicant: Michael Steven CHIU, North York (CA)

(72) Inventor: Michael Steven CHIU, North York (CA)

(73) Assignee: ClearWorld Media, Beijing (CN)

(21) Appl. No.: 13/549,157

(22) Filed: Jul. 13, 2012

(51) Int. Cl. G09G 5/00

(52) U.S. Cl. 345/633

(57) ABSTRACT

This relates to augmented reality systems. The augmented reality system may display a computer-generated image of a virtual object overlaid on a view of a physical, real-world environment. The system may allow users to move their associated virtual objects to real-world locations by changing the location data associated with the virtual objects. The system may also allow users to observe an augmented reality view having both a real-world view of an environment as captured by an image sensor and computer-generated images of the virtual objects located within the view of the image sensor. A user may then capture a virtual object displayed within their augmented reality view by taking a picture of the mixed-view image having the virtual object overlaid on the real-world view of the environment.

### BACKGROUND

1. Field

The present disclosure relates generally to augmented reality systems and, more specifically, to augmented reality systems for applications.

2. Related Art

Augmented reality systems typically display a view of a physical, real-world environment that can be enhanced with the inclusion of computer-generated images. These systems can be used in a wide range of applications, such as televised sporting events, navigation systems, mobile applications, and the like. While augmented reality systems have been used to improve a user's experience in various applications, conventional uses of augmented reality systems provide little to no real-world interaction between users. Additionally, conventional augmented reality systems provide little to no support for sharing an augmented reality experience between users.

### BRIEF SUMMARY

Systems and methods for operating an augmented reality system are disclosed herein. In one embodiment, the method may include receiving, at a server, location information associated with a mobile device, identifying a set of virtual objects from a plurality of virtual objects based on the location information associated with the mobile device and location information associated with each of the plurality of virtual objects, wherein each of the plurality of virtual objects is associated with one or more users, and transmitting the location information associated with each virtual object of the set of virtual objects to the mobile device. The method may further include receiving, at the server, a mixed-view image comprising a visual representation of a virtual object of the set of virtual objects overlaid on a real-world image captured by the mobile device.

In another embodiment, the method may include receiving location information associated with a mobile device, causing the transmission of the location information associated with the mobile device, and receiving location information associated with one or more virtual objects from a plurality of virtual objects. The method may further include receiving real-world view data generated by an image sensor of the mobile device, causing a display of a visual representation of a virtual object of the one or more virtual objects overlaid on a real-world image generated based on the real-world view data, generating a mixed-view image comprising the visual representation of the virtual object of the one or more virtual objects overlaid on the real-world image generated based on the real-world view data, and causing transmission of the mixed-view image.

Systems for performing these methods are also provided.

### DESCRIPTION OF THE FIGURES

FIG. 1 illustrates a block diagram of an exemplary system for supporting an augmented reality system according to various embodiments.

FIG. 2 illustrates an exemplary interface for registering with an augmented reality system according to various embodiments.

FIGS. 3-5 illustrate exemplary interfaces for an augmented reality system according to various embodiments.

FIG. 6 illustrates an exemplary process for operating an augmented reality system according to various embodiments.

FIGS. 7-11 illustrate exemplary interfaces for an augmented reality system according to various embodiments.

FIG. 12 illustrates an exemplary process for operating an augmented reality system according to various embodiments.

FIG. 13 illustrates an exemplary computing system that can be used within an exemplary augmented reality system according to various embodiments.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

This relates to mobile gaming applications having an augmented reality system. The augmented reality system may display a computer-generated image of a virtual object overlaid on a view of a physical, real-world environment. The virtual object may represent an object that exists within a virtual world, but does not exist in the real-world. Thus, the system may display a mixed-view image having a real-world component and a computer-generated component. Additionally, the virtual objects may each have location data associated therewith. The location data may correspond to real-world locations represented by, for example, geodetic coordinates. Thus, while the virtual object may not exist in the real-world, a virtual object may still be “located” at a real-world location. In this way, the augmented reality system may display a mixed-view having a real-world view (e.g., an image or video) of a physical, real-world environment as well as one or more virtual objects that are “located” within the view of the real-world environment.

In some embodiments, the augmented reality system may allow users to “move” their associated virtual objects to various real-world locations by changing the location data associated with the virtual objects. The system may also allow users to observe an augmented reality view having both a real-world view of an environment as captured by a camera or image sensor and computer-generated images of the virtual objects located within the view of the camera or image sensor. A user may then “capture” a virtual object displayed within their augmented reality view by taking a picture of the mixed-view image having the virtual object overlaid on the real-world view of the environment. The mixed-view image may be transmitted to a server and subsequently transmitted to a user associated with the captured virtual object. In this way, users may move their virtual objects to locations around the world and may receive pictures taken by other users located at or near the location of their virtual object.

While the examples below describe a virtual object as being a virtual bird, it should be appreciated that the principles described herein may be applied to other applications.

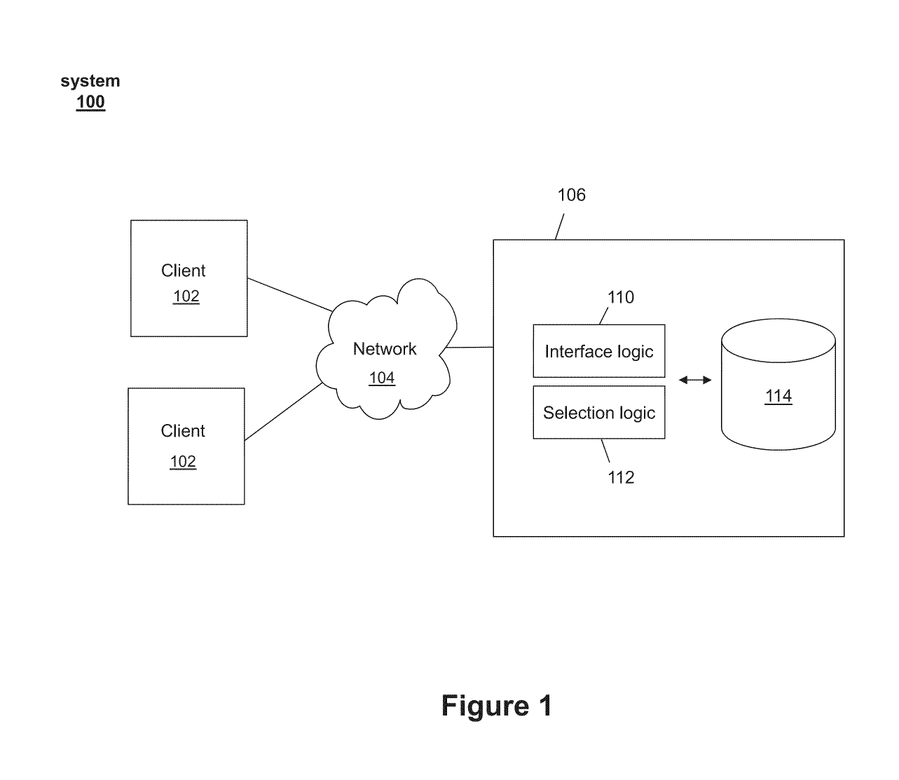

FIG. 1 illustrates a block diagram of an exemplary system 100 for providing an augmented reality service. Generally, system 100 may include multiple client devices 102 that may access a server 106. The server 106 and clients 102 may include any one of various types of computer devices, having, for example, a processing unit, a memory (including a permanent storage device), and a communication interface, as well as other conventional computer components (e.g., input device, such as a keyboard and mouse, output device, such as display). For example, client computer 102 may include a desktop computer, laptop computer, wired/wireless gaming consoles, mobile device, such as a mobile phone, web-enabled phone, smart phone, tablet, and the like. In some examples, client device 102 may include a display, image sensor, three-dimensional (3D) gyroscope, accelerometer, magnetometer, global positioning system (GPS) sensor, or combinations thereof.

Client devices 102 and server 106 may communicate, for example, using suitable communication interfaces via a network 104, such as the Internet. Client devices 102 and server 106 may communicate, in part or in whole, via wireless or hardwired communications, such as Ethernet, IEEE 802.11a/b/g/n/ac wireless, or the like. Additionally, communication between client devices 102 and server 106 may include various servers, such as a mobile server or the like.

Server 106 may include or access interface logic 110, selection logic 112, and database 114. In one example, database 114 may store data associated with virtual objects along with user data associated with the users of client devices 102. In one example, interface logic 112 may communicate data to client devices 102 that allows client devices 102 to display an interface as described herein. Further, interface logic 110 may receive data from client devices 102, including device positional data, virtual object positional data, user data, uploaded mixed-view images, and the like.

In one example, selection logic 112 may be used to select a set of virtual objects, for example, stored within database 114, to a client device 102. Selection logic 112 may select the subset of virtual objects based at least in part on a location of the client device 102 and/or other factors. As described herein, the set of virtual objects may then be displayed on the client device 102 to generate an augmented reality view. Various examples and implementations of selection logic 112 are described in greater detail below.

Server 106 may be further programmed to format data, accessed from local or remote databases or other sources of data, for presentation to users of client devices 102, preferably in the format discussed in detail herein. Server 106 may utilize various Web data interface techniques such as Common Gateway Interface (CGI) protocol and associated applications (or “scripts”), Java® “servlets”, i.e., Java applications running on the Web server, an application that utilizes Software Development Kit Application Programming Interfaces (“SDK APIs”), or the like to present information and receive input from client devices 102. Server 106, although described herein in the singular, may actually include multiple computers, devices, backends, and the like, communicating (wired and/or wirelessly) and cooperating to perform the functions described herein.

It will be recognized that, in some examples, individually shown devices may comprise multiple devices and be distributed over multiple locations. Further, various additional servers and devices may be included such as web servers, media servers, mail servers, mobile servers, advertisement servers, and the like as will be appreciated by those of ordinary skill in the art.

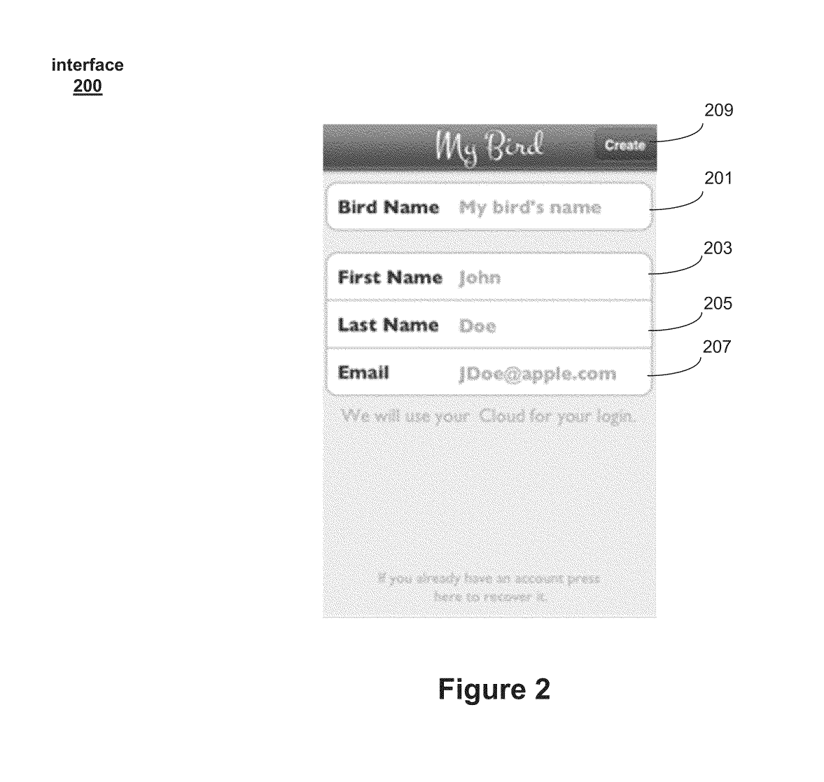

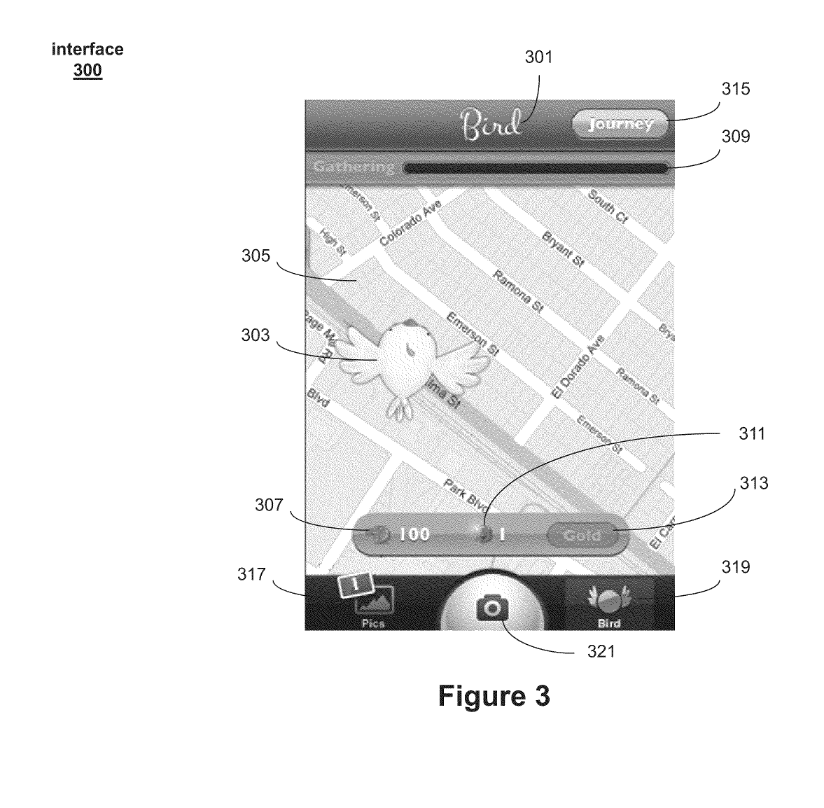

FIG. 2 illustrates an exemplary interface 200 that can be displayed by client device 102 and used to register with system 100. Interface 200 may include text entry field 201 for entering a name for a virtual object (e.g., a virtual bird) to be associated with the user. Interface 200 may further include text entry fields 203, 205, and 207 for entering a first name, last name, and email address, respectively, of the user. In response to a selection of the “create” button 209, the client device 102 may transmit the data entered in text fields 201, 203, 205, and 207 to server 106. In some examples, additional information, such as a geographic location (e.g., as represented by geodetic latitude and longitude values according to WGS84 or other coordinate systems), of the client device 102 as determined by a GPS sensor within the device may also be transmitted to server 106. At server 106, the data may be received and stored in database 114. Once the user has created his/her virtual object, the interface of FIG. 3 may be displayed.

In some embodiments, an additional interface may be provided to select or modify the appearance of the virtual object. For example, an interface that allows a user to select a color, size, shape, type, clothing, makeup, emotions, accessories including, but not limited to, jewelry, hats, and glasses, and the like, of a virtual bird may be provided.

FIG. 3 illustrates an exemplary interface 300 that can be displayed by client device 102. Interface 300 may be displayed when “bird” view 319 is selected within the interface. This view shows details associated with the user's virtual object (e.g., virtual bird). For example, interface 300 may include name 301 of the virtual object provided in text entry field 201 of interface 200. Interface 300 may further include a visual representation of the user's virtual object 303 overlaid on a map 305 at a location corresponding to a location of the virtual object. The initial location of the virtual object 303 can be determined based on the location data transmitted to server 106 during registration using interface 200.

Interface 300 can further include a first resource indicator 307 for showing an amount of a first resource that is available to virtual object 303. For instance, in some examples, the resources represented by indicator 307 can be virtual food available for a virtual bird. The virtual food can be used to move the virtual bird a distance depending on the amount of virtual food available. In some examples, the resource represented by indicator 307 can replenish over time as indicated by gathering bar 309.

Interface 300 can further include second resource indicator 311 for showing an amount of a second resource that is available to virtual object 303. For instance, in some examples, the resources represented by indicator 307 can be virtual coins available for a virtual bird. The virtual coins can be used to purchase an amount of the first resource represented by indicator 307 or speedup a travel time of virtual object 303. In some examples, the second resource may not replenish overtime and, instead, can be purchased using a real currency. Interface 300 can further include “gold” button 313 that can cause a display of an interface to allow the user to purchase an amount of the second resource using a real currency (e.g., U.S. dollars).

Interface 300 can further include “pics” button 317 to switch to a picture view. In the picture view, mixed-view images of the user's virtual object 303 as captured (e.g., pictures taken of virtual object 303) by other users may be displayed. These mixed-view images and processes for capturing virtual objects will be described in greater detail below.

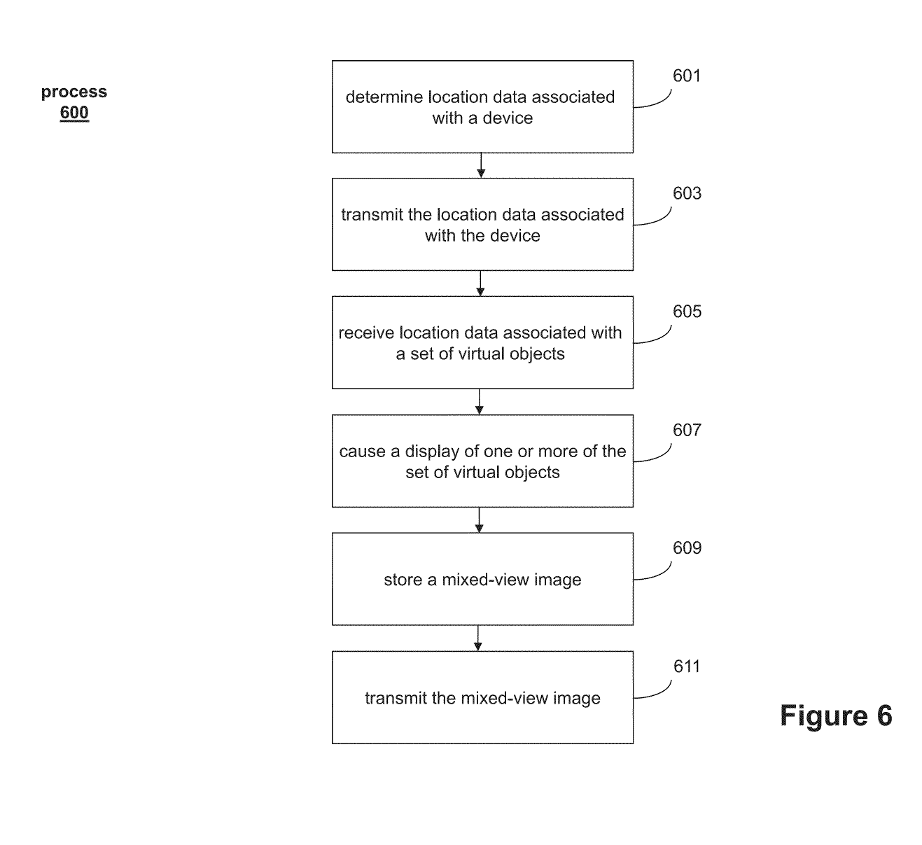

Interface 300 may further include a camera button 321. Button 321 may cause client device 102 to activate an image sensor within the device in order to capture another virtual object. The process to capture another virtual object will be described in greater detail below with respect to FIG. 6.

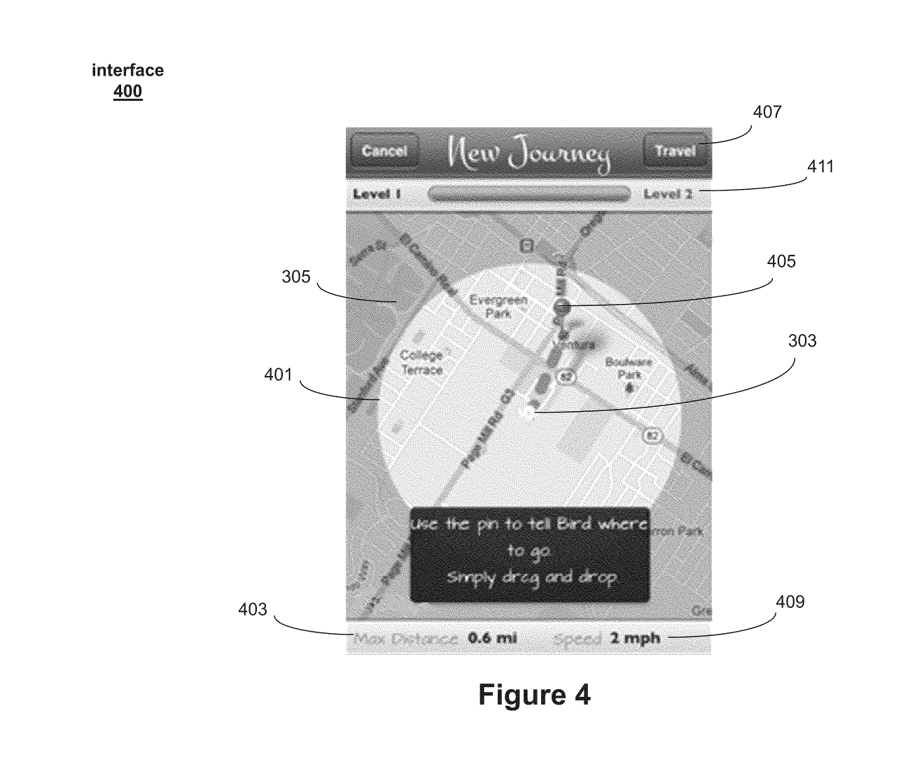

Interface 300 can further include “journey” button 315 for moving virtual object 303. As mentioned above, virtual object 303 may not exist in the real-world and thus, may not actually move to a real-world location. Instead, location data associated with virtual object 303 may be modified by server 106. In response to a selection of button 315, client device 102 may display interface 400 shown in FIG. 4. Interface 400 may be a variation of interface 300 that allows a user to change a location of virtual object 303. Interface 400 may include a visual representation of virtual object 303 overlaid on a map 305. Interface 400 may further include region 401 indicative of possible locations to which virtual object 303 may travel. In the illustrated example, region 401 is represented using a highlighted circle having a radius equal to the maximum travel distance 403 of virtual object 303. Interface 400 further includes pin 405 for selecting a travel destination with region 401. Pin 405 may be selected by the user and moved to a desired travel destination. In one example, pin 405 can be selected (e.g., clicked, tapped, “pinched,” or selected using any other means) and dragged to the desired travel destination. Once pin 405 has been positioned at the desired destination, the user may select “travel” button 407 to cause virtual object 303 to begin traveling to the new destination at a travel speed 409 of virtual object 303. Additionally, in response to a selection of button 407, a location associated with pin 405 may be transmitted by client device 102 to server 106. Server 106 may store the received location as the new location of virtual object 303 within database 114. In some examples, the new location may not become active until a threshold length of time expires (e.g., based on the distance between the current location of virtual object 303, the new location of virtual object 303, and the speed 409 of virtual object 303).

In some examples, interface 400 may further include level indicator 411 for displaying a level progress of virtual object 303. For example, a level associated with virtual object 303 may be increased each time virtual object 303 travels or performs some other operation. The amount of progress that virtual object 303 experiences may depend on the distance traveled, the task performed, or some other metric. In some examples, the level of virtual object may result in a change of the maximum distance 403 that virtual object 303 may travel or the speed 409 at which virtual object 303 may travel.

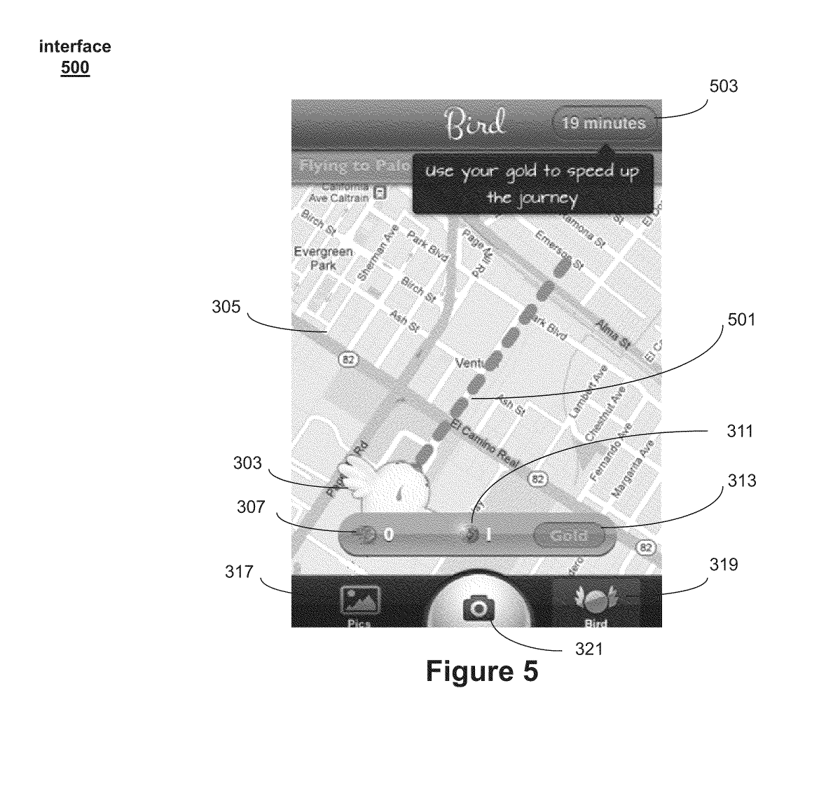

In response to a selection of button 407, client device 102 may display interface 500 shown in FIG. 5. Interface 500 may be a variation of interfaces 300 and 400 that shows a travel progress of virtual object 303. Interface 500 may include a visual representation of virtual object 303 overlaid on a map 305. Interface 500 may further include elements 307, 311, 313, 317, 319, and 321 similar to that of FIG. 3, described above. However, as shown in FIG. 5, the first resource indicator 307 may now display a smaller value representing the amount of first resource available to virtual object 303. This can be due to an amount of the first resource consumed to allow virtual object 303 to travel as instructed using interface 400. Additionally, interface 500 may further include travel indicator 501 for showing a travel path for virtual object 303. Interface 500 may further include time indicator 503 for showing a time remaining before virtual object 303 reaches the target destination. In some examples, time indicator 503 can be selected by the user to cause the time to be decreased in exchange for the second resource represented by indicator 311. For example, a user may spend coins in exchange for an immediate reduction in travel time.

As shown in FIG. 3 and FIG. 5, interfaces 300 and 500 may include a camera button 321. Button 321 may cause client device 102 to activate an image sensor within the device and may cause client device 102 to perform at least a portion of process 600 shown in FIG. 6.

At block 601 of process 600, location data associated with a device may be determined. For example, client device 102 may include a GPS sensor and may use the sensor to determine geodetic coordinates associated with client device 102. In other examples, other types of sensors may be used and/or other location data may be determined at block 601. For instance, Global Navigation Satellite System (GLONASS) technology or cellular positioning technology may also be used to determine a location of client device 102. Alternatively, a user may manually input a location, for example, by dropping a pin on a map.

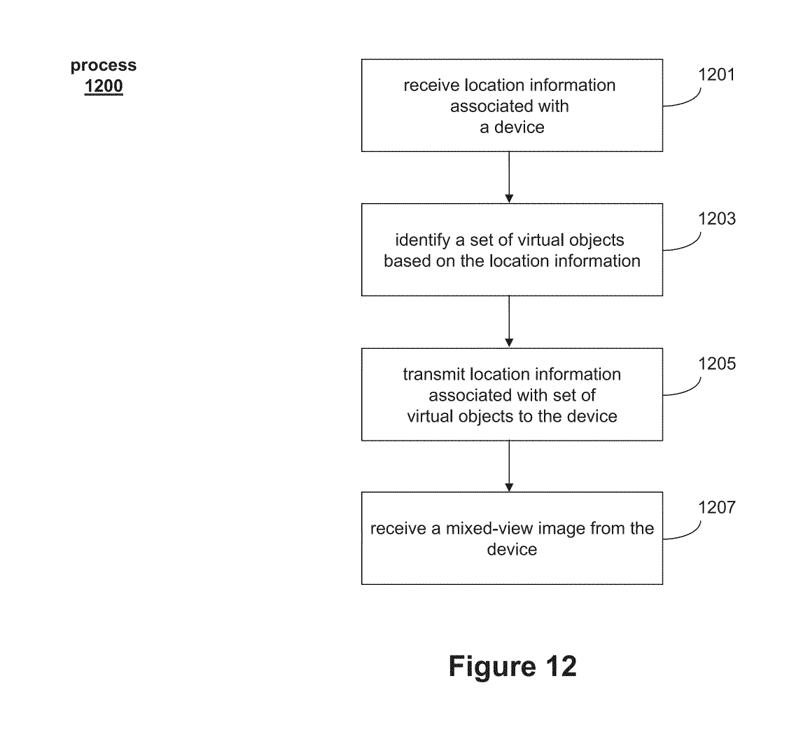

At block 603, the location data associated with the device may be transmitted. For example, location data associated with client device 102 determined at block 601 may be transmitted to server 106. At block 605, location data associated with a set of virtual objects may be received. For example, client device 102 may receive geodetic coordinates associated with one or more virtual objects (e.g., other virtual birds associated with other users) from server 106. The location data associated with the set of virtual objects may have been retrieved by server 10 from database 114. In some examples, as will be described in greater detail below with respect to FIG. 12, server 106 may select the set of virtual objects based at least in part on the location data associated with the device determined at block 601. For example, server 106 may return location data associated with a set of virtual objects containing at least one virtual object located near client device 102.

At block 607, a display of a visual representation of one or more of the set of virtual objects may be generated. For example, client device 102 may cause a display of a visual representation of one or more virtual objects of the set of virtual objects overlaid on a real-world view (e.g., an image or video) of an environment captured by an image sensor of client device 102.

In some examples, to display the visual representation of one or more of the set of virtual objects, the Cartesian coordinates (X, Y, Z) of the virtual objects may be determined relative to client device 102 (e.g., Cartesian coordinates centered around device 102). In some examples, the location of client device 102 may be provided in the form of longitude and latitude coordinates by a GPS sensor (or other positioning sensor or manually by the user) within device 102 and the locations of the virtual objects of the set of virtual objects may be provided by server 106 in the form of latitude and longitude coordinates. These longitude-latitude coordinates may then be transformed into Earth-centered Cartesian coordinates called Earth-centered Earth-fixed (ECEF) coordinates using transform base conversions known to those of ordinary skill in the art. The ECEF coordinates provide location information in the form of X, Y, Z coordinates that are centered around the center of the Earth. The ECEF coordinates of the virtual objects may then be converted to local East, North, up (ENU) coordinates that provide location information in the form of X, Y, Z coordinates on a plane tangent to the Earth's surface centered around a particular location (e.g., client device 102 as defined by the ECEF coordinates of device 102). The conversion from ECEF to ENU can be performed using techniques known to those of ordinary skill in the art. For example, the Newton-Raphson method can be used. In some examples, an accelerometer of device 102 can be used to identify the downward direction relative to device 102 and a magnetometer of device 102 can be used to identify the north direction relative to device 102. From these directions, the East direction may be extrapolated. In this way, the virtual objects can be placed around client device 102 using the ENU coordinates of the virtual objects.

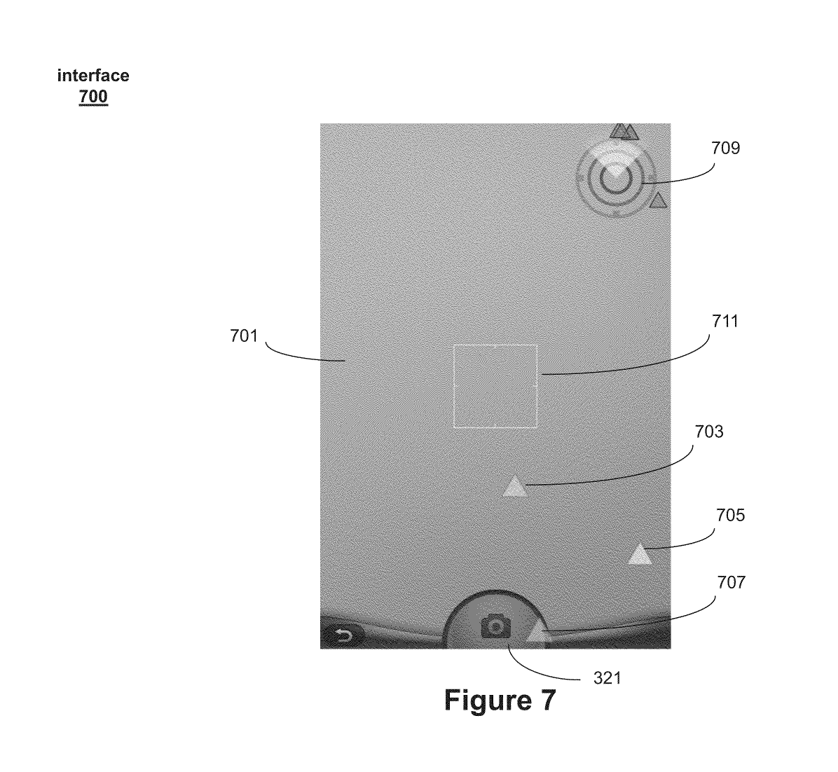

FIG. 7 illustrates an exemplary interface 700 that may be displayed at block 607. Interface 700 includes a displayed real-world view 701 showing an image or video captured by the image sensor of client device 102. Interface 700 further includes visual representations of virtual objects 703, 705, and 707 overlaid on the real-world view 701. Interface 700 further includes radar indicator 709 for providing information associated with the orientation of client device 102 and position of client device 102 relative to the set of virtual objects received from server 106. Specifically, indicator 709 includes a highlighted pie-shaped portion identifying a direction that the image sensor of client device 102 is facing. Indicator 709 further includes visual representations of virtual objects relative to a center of the indicator (corresponding to a position of client device 102). For example, indicator 709 includes four visual representations of virtual objects within the highlighted pie-shaped portion. This indicates that there are four virtual objects (including virtual objects 703, 705, and 707) in the field of view of the image sensor. Indicator 709 further includes a visual representation of a virtual object near the bottom right of the indicator 709. This represents a virtual object located to the right of and behind client device 102.

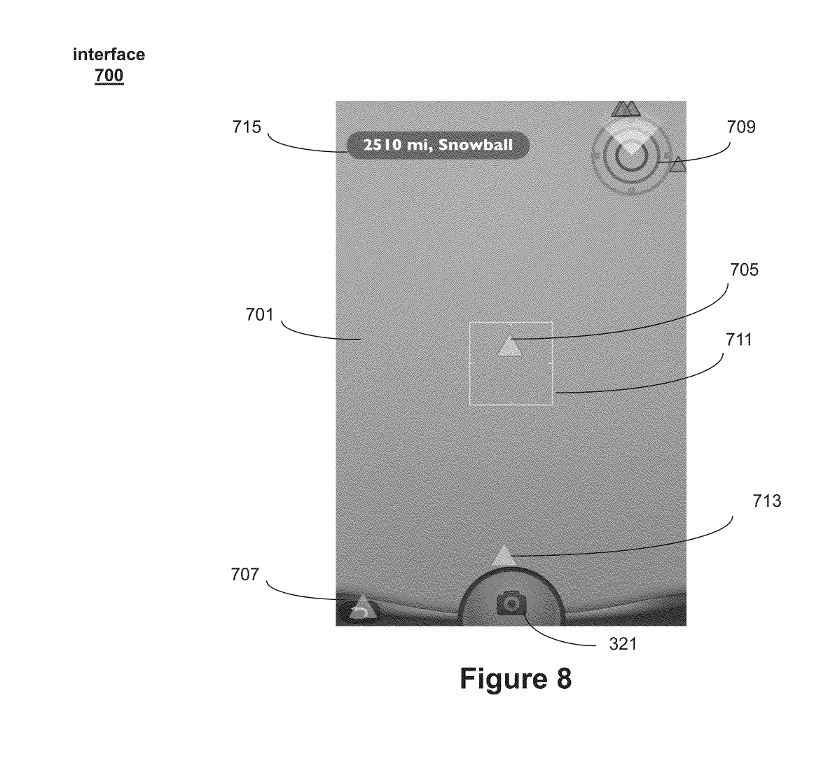

As mentioned above, client device 102 may include a 3D gyroscope and an accelerometer. Client device 102 may use data received from these sensors to identify and quantify motion of client device 102 within free-space. This information can be used to move virtual objects 703, 705, and 707 within interface 700 as if they were located within the real-world. The information from the 3D gyroscope and accelerometer may also be used to update the orientation of client device 102 and its position relative to the set of virtual objects as indicated by indicator 709. For example, if a user rotates client device 102 down and to the right, interface 700 may be updated as shown in FIG. 8. Specifically, as shown in FIG. 8, virtual object 705 may now be centered within viewfinder 711, virtual object 707 may be displayed near the bottom left corner of interface 700, and a previously hidden (not displayed) virtual object 713 may be displayed below virtual object 705. While not evident from the image shown in FIG. 8, the displayed real-world view 701 may also be updated to reflect the images being captured by the image sensor of client device 102. In this way, client device 102 may display a mixed-view having an image of a real-world environment (reflected by the real-world view 701 captured by the image sensor) combined with virtual objects (e.g., virtual objects 703, 705, 707, and 713) that can be viewed as if the virtual objects existed in the real-world.

In some examples, once a virtual object (e.g., virtual object 705) is centered within viewfinder 705, data associated with that virtual object may be displayed by virtual object indicator 715. Indicator 715 may include a name of the virtual object displayed within viewfinder 711 and a distance (e.g., real-world distance) between the location of client device 102 and the location of the virtual object displayed within viewfinder 711. For example, indicator 715 indicates that virtual object 705 is named “Snowball” and that virtual object 705 is located 2510 miles away from client device 102.

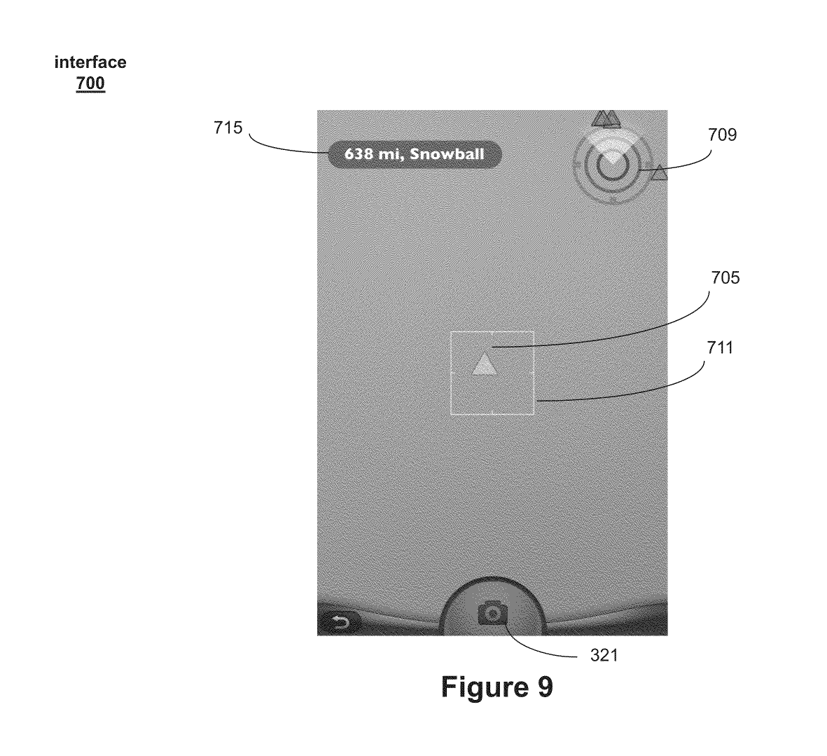

In some examples, while a virtual object is held within viewfinder 711 (e.g., while the client device 102 is pointed at a location of the virtual object), the virtual object may temporarily “travel” towards client device 102. In other words, a distance as indicated by indicator 715 may decrease while the virtual object remains within viewfinder 711. For example, FIG. 9 illustrates virtual object 705 held within viewfinder 711. As a result, a distance indicated by indicator 715 has decreased from 2510 miles in FIG. 8 to 638 miles in FIG. 9.

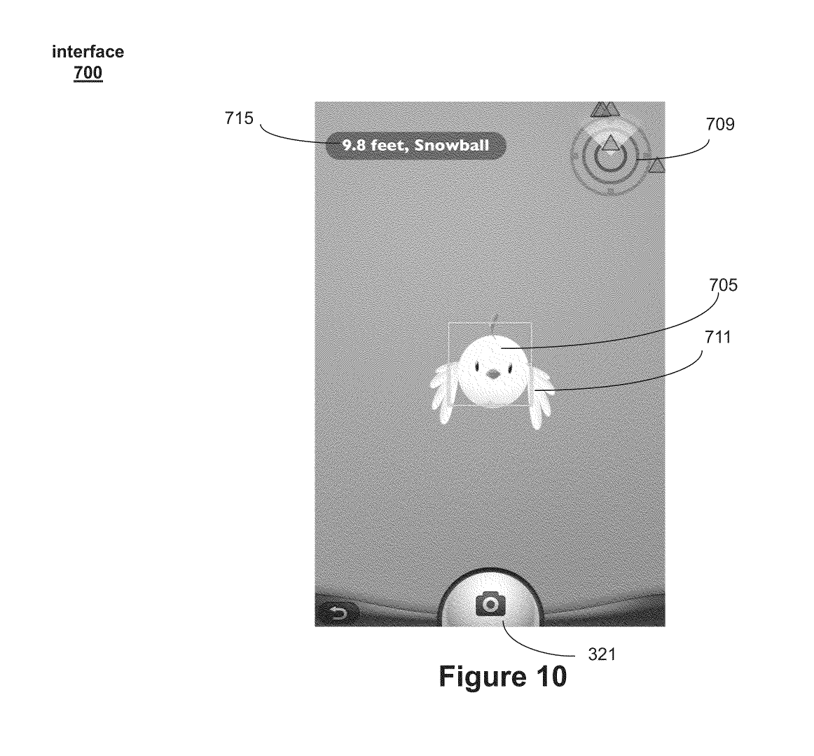

If the user keeps client device 102 pointed at the virtual object (e.g., keeps the virtual object within viewfinder 711), the virtual object may eventually arrive at the same or similar location as client device 102. For example, indicator 715 in FIG. 10 shows that virtual object 705 is 9.8 feet away from client device 102. As a result, the visual representation of virtual object 705 has changed from a triangle to a bird. The visual representation may change once the virtual object is within a threshold distance from the client device. The threshold distance can be selected to be any desired value. Once the virtual object is within the threshold distance, camera button 321 may become highlighted, indicating to the user that the virtual object 705 may be captured (e.g., a picture may be taken of virtual object 705).

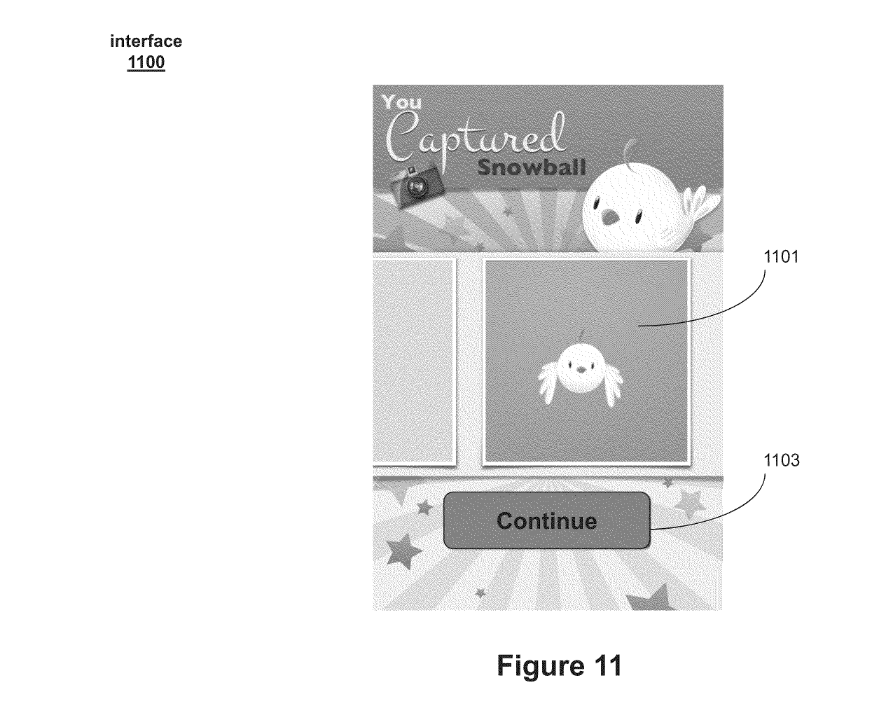

Referring back to FIG. 6, at block 609, a mixed-view image may be stored. The mixed-view image may include a real-world image (e.g., an image captured by an image sensor) along with a computer-generated image of a virtual object (e.g., the visual representation of virtual object 705). For example, referring back to FIG. 10, in response to a selection of button 321, the image currently being displayed within interface 700 may be stored in memory on client device 102. Additionally, in response to a selection of button 321, client device 102 may display interface 1100 shown in FIG. 11. Interface 1100 may include a thumbnail image 1101 of the image stored in memory when button 321 was selected. In some examples, additional images of the virtual object taken by other users may be viewed alongside thumbnail image 1101. Interface 1103 may further include a “Continue” button 1103. Button 1103 may provide the user of client device 102 with one or more options, such as publishing the image to a social networking website, saving the image in a photo library, or accepting an incentive reward for taking a picture of another user's virtual object. The reward can be any reward to incentivize a user to take pictures of virtual objects. For example, the user may be rewarded with an amount of the first resource (e.g., food), an amount of the second resource (e.g., coins), an amount of both the first resource and an amount of the second resource, or the user may be rewarded by allowing his/her virtual object to progress in levels.

Referring back to FIG. 6, at block 611, the mixed-view image may be transmitted. For example, client device 102 may transmit the mixed-view image to server 106 through network 104.

FIG. 12 illustrates an exemplary server-side process 1200 for operating an augmented reality system similar or identical to system 100. At block 1201, location information associated with a device may be received. For example, geodetic location data associated with a mobile client device 102 may be received by server 106. In some examples, the location data received at block 1201 may be similar or identical to the location data transmitted by client device 102 at block 603 of process 600.

At block 1203, a set of virtual objects may be identified based on the location information received at block 1201. For example, server 1201 may use selection logic 110 to identify one or more virtual objects stored in database 114 based on location information associated with the client device 102. In one example, server 106 using selection logic 110 may attempt to find virtual objects (e.g., virtual birds) near a location of the client device 102. For example, if a user of client device 102 is located in Paris, France, then the server may attempt to find virtual objects in Paris, France. The identification of virtual objects near a particular location may be determined in many ways. In one example, selection logic 110 of server 106 may identify all virtual objects located in an area within a threshold number of degrees latitude and longitude of client device 102 as defined by the location information received at block 1201. Any desired threshold number of degrees may be used (e.g., 0.25, 0.5, 1, or more degrees can be used). In other examples, server 106 using selection logic 110 may alternatively attempt to find virtual objects (e.g., virtual birds) near a location of the virtual object of the user of client device 102. For example, if the user of client device 102 has sent his/her virtual object to San Francisco, Calif., then selection logic 110 of server 106 may identify all virtual objects within a threshold number of degrees latitude and longitude of the virtual object owned by the user of client device 102 as defined by the virtual object data stored in database 114.

In some examples, selection logic 110 of server 106 may search database 114 for virtual objects near the client device 102 (or alternatively the virtual object owned by the user of client device 102) until a threshold number of virtual objects are identified. For example, selection logic 110 may search for all objects within 0.5 degrees latitude and longitude of the client device 102. If that search returns fewer than a threshold number of virtual objects (e.g., 10 objects), then selection logic 110 may expand the search criteria (e.g., all objects within 1 degree latitude and longitude of the client device 102) and perform the search again. If the search still returns fewer than the threshold number of virtual objects, the search criteria can be further expanded. The amount that the search criteria may be expanded for each subsequent search may be any value and can be selected based on the available pool of virtual objects. Once the selection logic 110 identifies the threshold number of virtual objects, the identified virtual objects may be filtered.

In one example, selection logic 110 may filter the identified list of virtual objects based on a length of time since each virtual object was captured (e.g., since a user took a picture of the virtual object using process 600). For example, selection logic 110 may rank the list of identified objects based on a length of time since each virtual object was captured. This can be done to prevent the same virtual objects from being presented to users. Once the prioritized list of virtual objects is generated, a predetermined number of the top virtual objects may be selected to be included in the set of virtual objects to be transmitted to the user of client device 102. In some examples, a second predetermined number of virtual objects from database 114 that were not already selected to be included within the set of virtual objects to be transmitted to client device 102 may be randomly selected for inclusion within the set. This can be done to add an element of surprise or randomness to the display of virtual objects. For example, this may allow a user having a virtual object located in Auckland, New Zealand to have their virtual object captured by a user in Reykjavik, Iceland.

At block 1205, the location information associated with the set of virtual objects may be transmitted to the device. For example, server 106 may transmit the locations of the virtual objects of the set of virtual objects to client device 102. The set of virtual objects may include the set of virtual objects identified at block 1203.

At block 1207, a mixed-view image may be received from the device. For example, a mixed-view image similar or identical to that transmitted at block 611 of process 600 may be received by server 106 from a mobile client device 102. Server 106 may then store the received mixed view image in database 114. In some examples, the mixed-view image may be pushed to a client device 102 associated with the virtual object captured in the mixed-view image. In other examples, the mixed-view image may be transmitted to the client device 102 associated with the virtual object captured in the mixed-view image in response to a request from that client device 102 (e.g., in response to a user selecting “pies” button 317 in interface 300 or 500).

Using processes 600 and 1200, a user may move his/her virtual object to various locations around the world. Other users near or far from the location of the virtual object may capture the virtual object, thereby returning a mixed-view image having a real-world view of an environment at a location of the capturing user along with a computer-generated image of the virtual object. In this way, a user may obtain images from other users taken at various locations around the world as well as share images taken at a location of the user with other users.

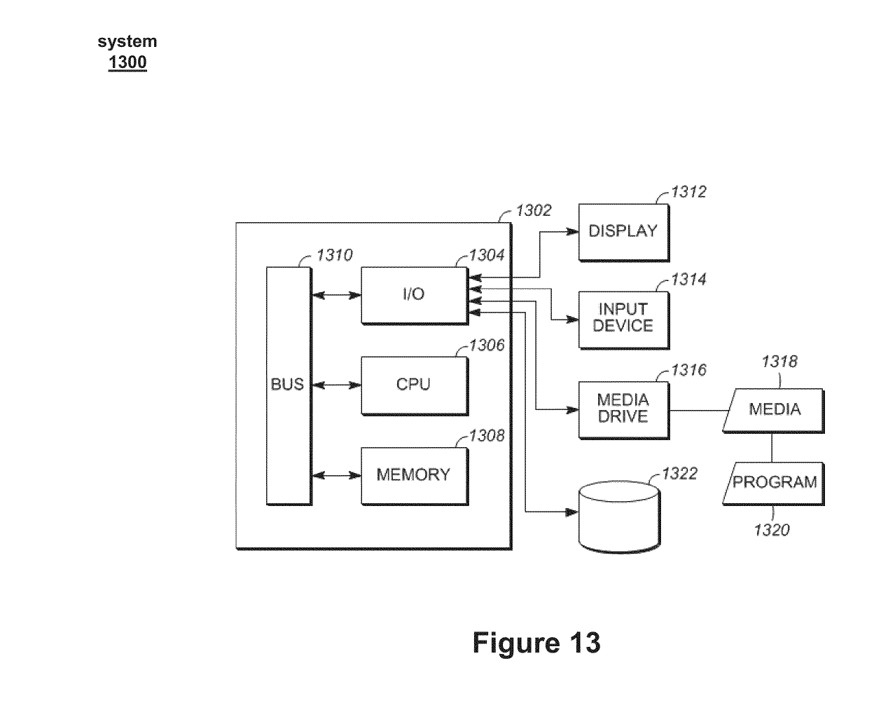

Portions of system 100 described above may be implemented using one or more exemplary computing systems 1300. As shown in FIG. 13, the computer system 1300 includes a computer motherboard 1302 with bus 1310 that connects I/O section 1304, one or more central processing units (CPU) 1306, and a memory section 1308 together. The I/O section 1304 may be connected to display 1312, input device 1314, media drive unit 1316 and/or disk storage unit 1322. Input device 1314 may be a touch-sensitive input device. The media drive unit 1316 can read and/or write a non-transitory computer-readable storage medium 1318, which can contain computer executable instructions 1320 and/or data.

At least some values based on the results of the above-described processes can be saved into memory such as memory 1308, computer-readable medium 1318, and/or disk storage unit 1322 for subsequent use. Additionally, computer-readable medium 1318 can be used to store (e.g., tangibly embody) one or more computer programs for performing any one of the above-described processes by means of a computer. The computer program may be written, for example, in a general-purpose programming language (e.g., C including Objective C, Java, JavaScript including JSON, and/or HTML) or some specialized application-specific language.

Although only certain exemplary embodiments have been described in detail above, those skilled in the art will readily appreciate that many modifications are possible in the exemplary embodiments without materially departing from the novel teachings and advantages of this disclosure. For example, aspects of embodiments disclosed above can be combined in other combinations to form additional embodiments. Accordingly, all such modifications are intended to be included within the scope of this technology.

What is claimed is:

1. A computer-implemented method for operating an augmented reality system, the method comprising:
receiving, at a server, location information associated with a mobile device;
identifying a set of virtual objects from a plurality of virtual objects based on the location information associated with the mobile device and location information associated with each of the plurality of virtual objects, wherein each of the plurality of virtual objects is associated with one or more users;
transmitting the location information associated with each virtual object of the set of virtual objects to the mobile device; and
receiving, at the server, a mixed-view image comprising a visual representation of a virtual object of the set of virtual objects overlaid on a real-world image captured by the mobile device.

2. The method of claim 1, wherein identifying the set of virtual objects is further based on an amount of gameplay amongst users.

3. The method of claim 1, wherein the method further comprises transmitting the mixed-view image to a user associated with the virtual object of the set of virtual objects.

4. The method of claim 1, wherein the method further comprises storing the received mixed-view image and associating the stored mixed-view image with a user associated with the virtual object of the set of virtual objects.

5. The method of claim 4, wherein the method further comprises:
receiving a request from the user for images associated with the user; and
transmitting one or more images to the user, wherein the one or more images comprises the mixed-view image.

6. The method of claim 1, wherein the method further comprises:
receiving a request from a user to move their associated virtual object; and
changing location information associated with the virtual object associated with the user.

7. The method of claim 1, wherein the location information associated with the mobile device comprises geodetic longitude and latitude data, and wherein the location information associated with each of the plurality of virtual objects comprises geodetic longitude and latitude data.

8. The method of claim 1, wherein the one or more virtual objects are identified based on their respective location information representing a location within a threshold distance from a location represented by the location information associated with the mobile device.

9. A computer-implemented method for an augmented reality system, the method comprising:
receiving location information associated with a mobile device;
causing the transmission of the location information associated with the mobile device;
receiving location information associated with one or more virtual objects from a plurality of virtual objects;
receiving real-world view data generated by an image sensor of the mobile device;
causing a display of a visual representation of a virtual object of the one or more virtual objects overlaid on a real-world image generated based on the real-world view data;
generating a mixed-view image comprising the visual representation of the virtual object of the one or more virtual objects overlaid on the real-world image generated based on the real-world view data; and
causing transmission of the mixed-view image.

10. The method of claim 9, wherein the mobile device comprises one or more of an accelerometer, a gyroscope, and a magnetometer, and wherein the method further comprises:
receiving orientation data from the one or more of the accelerometer, the gyroscope, and the magnetometer; and
determining a view of the mobile device based on the orientation data, wherein the visual representation of the virtual object is selected for display overlaid on the real-world image based on the location information associated with the virtual object corresponding to a location within the determined view of the mobile device.

11. The method of claim 9, wherein each object of the plurality of objects is associated with a respective user, and wherein the method further comprises:
transmitting a request for images associated with a user;
receiving one or more images associated with the user; and
causing a display of at least one of the one or more images associated with the user.

12. The method of claim 9, wherein each object of the plurality of objects is associated with a respective user, and wherein the method further comprises transmitting a request to change a location of the virtual object associated with a user.

13. The method of claim 9, wherein the method further comprises:
causing a display of a visual representation of a virtual object associated with a user of the mobile device overlaid on a map, wherein the virtual representation of the virtual object is displayed on a portion of the map corresponding to location information associated with the virtual object.

14. The method of claim 9, wherein the location information associated with the mobile device comprises geodetic longitude and latitude data, and wherein the location information associated with each of the plurality of virtual objects comprises geodetic longitude and latitude data.

15. An augmented reality system comprising:
a database comprising location information associated with a plurality of virtual objects; and
a server configured to:
receive location information associated with a mobile device;
transmit location information associated with each of one or more virtual objects of the plurality of virtual objects to the mobile device, wherein the one or more virtual objects are identified from the plurality of virtual objects based on the location information associated with the mobile device and the location information associated with each of the plurality of virtual objects, wherein each of the plurality of virtual objects is associated with one or more users; and
receive a mixed-view image comprising a visual representation of a virtual object of the one or more virtual objects overlaid on a real-world image captured by the mobile device.

16. The system of claim 15, wherein the server is further configured to transmit the mixed-view image to a user associated with the virtual object of the one or more virtual objects.

17. The system of claim 15, wherein the database is configured to store the received mixed-view image such that the stored mixed-view image is associated with a user associated with the virtual object of the one or more virtual objects.

18. The system of claim 17, wherein the server is further configured to:
receive a request from the user for images associated with the user; and
transmit one or more images to the user, wherein the one or more images comprises the mixed-view image.

19. A augmented reality device comprising:
a global positioning device;
an image sensor; and
a processor configured to
receive location information from the global positioning device;
cause the transmission of the location information associated with the mobile device;
receive location information associated with one or more virtual objects from a plurality of virtual objects;
receive real-world view data generated by the image sensor;
cause a display of a visual representation of a virtual object of the one or more virtual objects overlaid on a real-world image generated based on the real-world view data;
generate a mixed-view image comprising the visual representation of the virtual object of the one or more virtual objects overlaid on the real-world image generated based on the real-world view data; and
cause the transmission of the mixed-view image.

20. The device of claim 19 further comprising:
a gyroscope; and
an accelerometer, wherein the processor is further configured to:
receive orientation data from the accelerometer and the gyroscope; and
determine a view of the device based on the orientation data, wherein the visual representation of the virtual object is selected for display overlaid on the real-world image based on the location information associated with the virtual object corresponding to a location within the determined view of the device.

21. The device of claim 19, wherein each object of the plurality of objects is associated with a respective user, and wherein the processor is further configured to:
transmit a request for images associated with a user;
receive one or more images associated with the user; and
cause a display of at least one of the one or more images associated with the user.

22. The device of claim 19, wherein each object of the plurality of objects is associated with a respective user, and wherein the processor is further configured to transmit a request to change a location of a virtual object associated with the user.

23. The device of claim 19, wherein the processor is further configured to:
cause a display of a visual representation of a virtual object associated with a user of the mobile device overlaid on a map, wherein the virtual representation of the virtual object is displayed on a portion of the map corresponding to location information associated with the virtual object.
